(19) United States
(12) Patent Application Publication
(10) Pub. No.: US 2026/0027681 A1
(43) Pub. Date: Jan. 29, 2026

(54) POWER TOOL WITH AUTOMATIC SHIFTING MECHANISM

(71) Applicant: MILWAUKEE ELECTRIC TOOL CORPORATION, Brookfield, WI (US)

(72) Inventors: Matthew G. Morris, Milwaukee, WI (US); Nathan P. Sievers, West Allis, WI (US); Mackenzie J. Nick, Theresa, WI (US)

(21) Appl. No.: 18/994,385

(22) PCT Filed: Jul. 14, 2023
(86) PCT No.: PCT/US2023/027833

§ 371 Date: Jan. 14, 2025

Related U.S. Application Data
(60) Provisional application No. 63/389,233, filed on Jul. 14, 2022.

(51) Int. Cl. B25B 21/00; B25B 23/147; B25F 5/00

(52) U.S. Cl. CPC B25B 21/008; B25B 23/147; B25F 5/001

(57) ABSTRACT

A power tool including a housing, a motor having an output shaft, a first gear set coupled to the output shaft, a second gear set, and an auto-shift mechanism. The motor is configured to drive rotation of the output shaft to generate torque. The auto-shift mechanism is positioned between the first gear stage and the second gear stage and provides at least a first torque transmission path and a second torque transmission path between the first gear set and the second gear set. The auto-shift mechanism is configured to transmit torque between the first gear set and the second gear set along the first path when torque generated by the motor is less than a critical torque and is configured to transmit torque between the first gear set and the second gear set when torque generated by the motor is greater than the critical torque.

### CROSS-REFERENCE TO RELATED APPLICATION

This application claims priority to U.S. Provisional Patent Application No. 63/389,233 filed on Jul. 14, 2022, the entire contents of which are incorporated herein by reference.

### FIELD

The present disclosure relates to power tools, and more specifically to shifting mechanisms for power tools.

### SUMMARY

In one aspect, the disclosure provides a power tool including a housing, a motor supported by the housing and including an output shaft, a first gear set, a second gear set, and an auto-shift mechanism. The housing includes an output end. The motor is configured to drive rotation of the output shaft to generate torque. The first gear set is coupled to the output shaft such that torque is transferred to the first gear set from the output shaft. The second gear set is positioned between the first gear set and the output end. The auto-shift mechanism is positioned between the first gear stage and the second gear stage. The auto-shift mechanism provides at least a first path of torque transmission and a second path of torque transmission between the first gear set and the second gear set. The auto-shift mechanism is configured to transmit torque between the first gear set and the second gear set along the first path when torque generated by the motor is less than a critical torque and is configured to transmit torque between the first gear set and the second gear set when torque generated by the motor is greater than the critical torque.

In some aspects, when the auto-shift mechanism transmits torque along the first path of torque transmission, the power tool operates at a relatively higher speed and a relatively lower torque than when the auto-shift mechanism transmits torque along the second path of torque transmission.

In some aspects, the auto-shift mechanism includes a shaft coupled to the first gear set, an output pinion coupled to the second gear set and configured to transmit torque to the second gear set, a spinner mounted on the shaft, a shift housing surrounding at least a portion of the shaft and the spinner. The spinner is configured to transmit torque to the output pinion when torque is transmitted through the first path of torque transmission, and the shift housing is configured to transmit torque to the output pinion when torque is transmitted through the second path of torque transmission. In some aspects, the first gear set includes a first planetary gear stage having a first carrier and a second planetary gear stage having a second carrier. The shaft is coupled to and is driven by the first carrier. The second carrier is coupled to and driven by the shaft. The shift housing is driven by the second carrier. In some aspects, the second carrier is integrally formed with the shift housing. In some aspects, the auto-shift mechanism further includes a plate mounted to the shaft for rotation with the shaft, and a plurality of clutch balls at least partially supported and configured to be rotationally driven by the plate. The spinner includes a plurality of apertures, each of the plurality of apertures configured to partially receive a corresponding one of the clutch balls such that the plate is configured to drive rotation of the spinner through the clutch balls such that torque is transmitted to the second gear set through the plate and the plurality of clutch balls in the first path of torque transmission. In some aspects, the plurality of clutch balls is configured to move out of the plurality of apertures of the spinner once torque generated by the motor reaches the critical torque to adjust torque transmission between the first gear set and the second gear set from the first path of torque transmission to the second path of torque transmission.

In some aspects, the power tool further includes a torque display in electrical communication with the torque transducer and configured to provide an indication when the torque generated by the motor reaches the critical torque value.

In another aspect, the disclosure provides a power tool including a housing, a motor supported by the housing and including an output shaft, a first gear set, a second gear set, and an auto-shift mechanism. The housing includes an output end. The motor is configured to drive rotation of the output shaft to generate torque. The first gear set is coupled to the output shaft such that torque is transferred to the first gear set from the output shaft. The second gear set is positioned between the first gear set and the output end. The auto-shift mechanism is configured to transmit torque from the first gear set to the second gear set. The auto-shift mechanism includes a shaft, an output pinion, and a plurality of shift balls. The shaft is coupled to the first gear set. The output pinion is coupled to the second gear set. The plurality of shift balls is configured to transmit torque to the output pinion. When the auto-shift mechanism reaches a critical torque, the shift balls are configured to move between a first position in which the plurality of shift balls transmit a first torque to the output pinion and a second position in which the plurality of shift balls transmit a second torque to the output pinion. The second torque is greater than the first torque.

In some aspects, the plurality of shift balls is positioned closer to the shaft in the first position than in the second position.

In some aspects, the first torque is a first range of torques, and the second torque is a second range of torques. A greatest torque value in the first range of torques is less than or equal to a lowest torque value in the second range of torques.

In some aspects, the auto-shift mechanism further includes a spinner mounted to shaft, and a shift housing surrounding at least a portion of the shaft, the plurality of shift balls, and the spinner. In the first position, the shift balls are positioned rotationally between the spinner and the output pinion, and in the second position, the shift balls are positioned rotationally between the shift housing and the output pinion. In some aspects, the output pinion extends from a lock ring having lock ring lobes. The spinner includes spinner lobes such that rotation of the spinner engages the spinner lobes with the shift balls to push the shift balls into the lock ring lobes and rotate the output pinion. The shift housing includes grooves configured to receive the shift balls when the shift balls are in the second position such that the rotation of the shift housing engages the shift housing with the shift balls in the grooves to push the shift balls into the lock ring lobes and rotate the output pinion. In some aspects, the auto-shift mechanism further includes a plate mounted to the shaft between the spinner and the first gear set, the plate mounted for rotation with and axial movement relative to the shaft, a spring biasing the plate toward the spinner, and a plurality of clutch balls supported between the plate and the spinner such that the plate is configured to drive rotation of the spinner through the clutch balls. When the auto-shift mechanism reaches the critical torque, the plurality of clutch balls move away from the spinner and push the plate against the bias of the spring such that the plate is inhibited from driving rotation of the spinner. In some aspects, the plate includes a plurality of ramps that defines a plurality of troughs between adjacent ramps. Each of the plurality of clutch balls is positioned in a corresponding one of the plurality of troughs when the auto-shift mechanism is operating below a critical torque. When the auto-shift mechanism reaches the critical torque, each of the plurality of clutch balls engages a corresponding one of the plurality of ramps to push the plate against the bias of the spring. In some aspects, the motor includes a plurality of stator coils switchable between a delta configuration and a wye configuration. In some aspects, the power tool further includes a controller configured to switch the plurality of stator coils from the delta configuration to the wye configuration when torque output by the motor reaches critical torque.

In another aspect, the disclosure provides, a power tool including a housing, a motor supported by the housing and including an output shaft, a first gear set, a second gear set, a torque transducer, auto-shift mechanism, and a display screen. The housing includes an output end. The motor is configured to drive rotation of the output shaft to generate torque. The first gear set is coupled to the output shaft such that torque is transferred to the first gear set from the output shaft. The second gear set is positioned between the first gear set and the output end. The toque transducer is configured to detect and measure the torque generated by the motor. The auto-shift mechanism is positioned between the first gear set and the second gear set and is configured to transmit torque from the first gear set to the second gear set. The auto-shift mechanism is configured to adjust the amount of torque transmitted from the first gear set to the second gear set after the measured torque reaches a predetermined critical value. The display screen is configured to display a value of torque generated by the motor is displayed such that the display screen provides an indication when the torque reaches the predetermined critical value.

In some aspects, the auto-shift mechanism includes a first torque transmitting mechanism configured to transmit torque from the first gear set to the second gear set before measured torque reaches the critical value and a second torque transmitting mechanism configured to transmit torque from the first gear set to the second gear set after measured torque reaches the critical value.

In some aspects, the power tool further includes a printed circuit board assembly including a controller in electrical communication with the torque transducer such that the controller is configured to receive a signal from the torque transducer indicating the measured torque. The motor includes a plurality of stator coils switchable between a delta configuration and a wye configuration, and the controller is configured to switch between the delta configuration and the wye configuration based on the measured torque.

Other features and aspects of the invention will become apparent by consideration of the following detailed description and accompanying drawings.

### BRIEF DESCRIPTION OF THE DRAWINGS

FIG. 1 is a front perspective view of a power tool in the form of a reaction arm tool according to an embodiment of the disclosure.

FIG. 2 is a cross-sectional view of the power tool of FIG. 1 taken along line 2-2.

FIG. 3 is an exploded view of an auto-shift mechanism for the power tool of FIG. 1.

FIG. 4 is a cross-sectional view of the auto-shift mechanism of FIG. 3 taken along a centerline of the auto-shift mechanism.

FIG. 5 is a perspective view of a portion of the auto-shift mechanism of FIG. 3.

FIG. 6 is a cross-sectional view of the power tool of FIG. 1 taken along line 6-6.

FIG. 7 is a front view of a torque transducer for the power tool of FIG. 1.

FIG. 8 is a rear perspective view of the power tool of FIG. 1.

FIG. 9 is cross-sectional view of a power tool including an auto-shift mechanism according to another embodiment of the disclosure.

FIG. 10 is a zoomed-in view of the auto-shift mechanism of FIG. 9.

FIG. 11 is a plan view of a portion of the auto-shift mechanism of FIG. 9.

FIG. 12 is a zoomed in view of the portion of the auto-shift mechanism of FIG. 11.

FIG. 13 is a perspective view of another portion of the auto-shift mechanism of FIG. 9.

FIG. 14 is a perspective view of another portion of the auto-shift mechanism of FIG. 9

FIG. 15 is a cross-sectional view of a power tool including an auto-shift mechanism according to another embodiment of the disclosure.

FIG. 16 is a zoomed-in view of the auto-shift mechanism of FIG. 15.

FIG. 17 is a plan view of a housing for the auto-shift mechanism of FIG. 15.

FIG. 18 is a cross-sectional view of a power tool including an auto-shift mechanism according to another embodiment of the disclosure.

FIG. 19 is a speed versus torque graph of the power tool of FIG. 18.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Referring generally to THE FIGURES the present disclosure provides, among other things, a power tool including an automatic shifting mechanism for automatically shifting the tool between a high-speed, low-torque state and a low-speed, high-torque state. In some embodiments, a torque transducer is located on a motor output shaft of the power tool, and a torque display is provided for displaying, or indicating, a torque output of the motor that is detected by the torque transducer. In some embodiments, the power tool has a soft start mode for gradually increasing a torque output as the power tool is turned on.

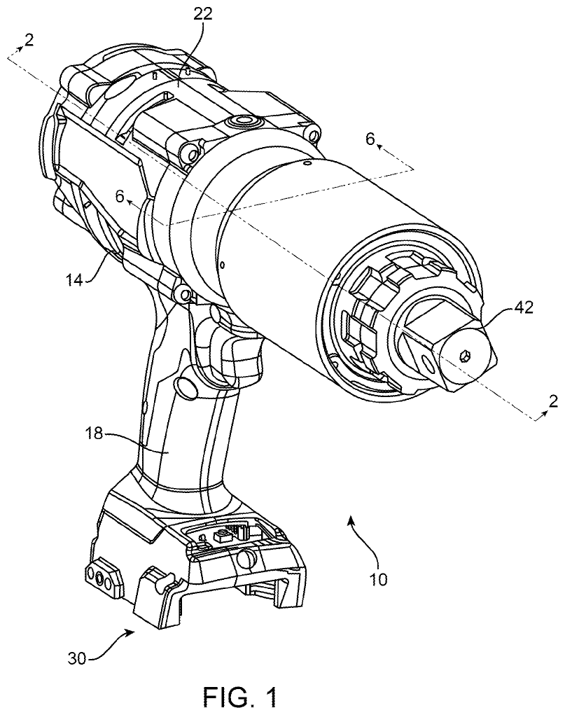

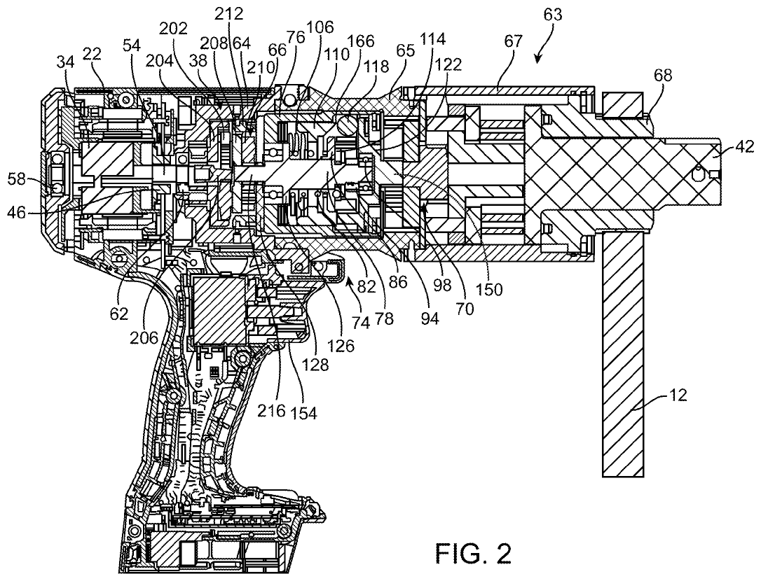

FIGS. 1 and 2 illustrate a power tool 10 in the form of a reaction arm tool-a rotary direct drive power tool configured to apply torque to a workpiece (e.g., a fastener) and having a reaction arm 12 (FIG. 2) that braces the tool against a fixed structure (e.g., an adjacent fastener, a wall, a clamp, etc.) to bear the reaction torque. As such, a user operating the power tool 10 does not experience the reaction torque on their hands and wrists allowing for higher torque outputs, repeatability, and reduced user fatigue.

With continued reference to FIGS. 1 and 2, the illustrated power tool 10 includes a housing 14 having a handle portion 18, a motor housing portion 22, and a battery receptacle 30 configured to receive a battery pack. In the illustrated embodiment, the battery receptacle 30 is located at a bottom end or foot of the handle portion 18 opposite the motor housing portion 22. A motor 34 is supported within the motor housing portion 22 and operably coupled to a transmission 38 (FIG. 2). The motor 34 drives the transmission 38 to provide an output torque at an output end or drive 42 of the power tool 10.

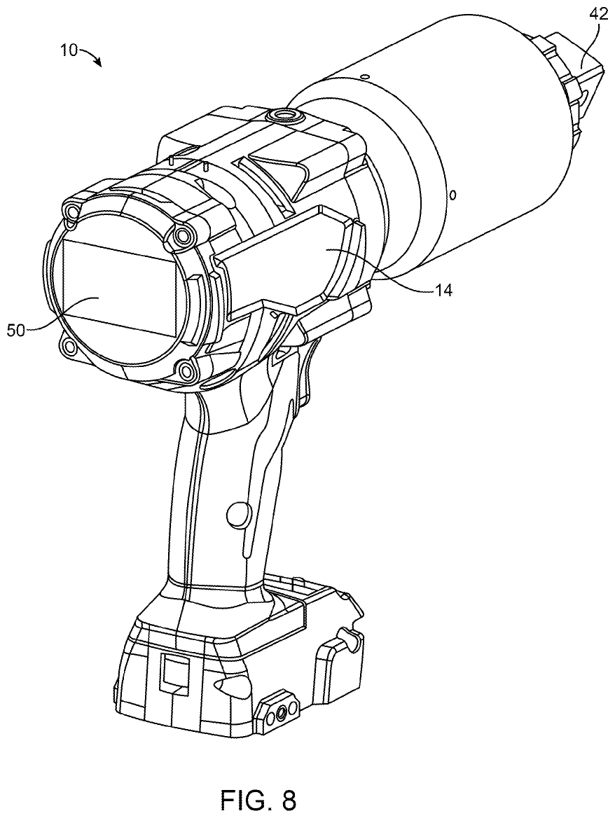

In the illustrated embodiment, the power tool 10 further includes a torque transducer 46 that may provide an indication of the torque level at which the power tool 10 is operating. Specifically, the torque transducer 46 may relay a signal (e.g., a voltage output, a current output, an analog output, a digital signal) indicating the torque level to a torque display screen 50 (FIG. 8). The torque transducer 46 may relay the signal to a microprocessor, or another similar electrical control unit, which converts the signal, such as the voltage output, into a torque value. The microprocessor may then relay the converted torque value to the torque display screen 50 to indicate a level of torque to a user. Optionally, the microprocessor may control one or more operational parameters of the power tool 10 (e.g., motor speed, motor shut-down, or the like) based on feedback from the torque transducer 46.

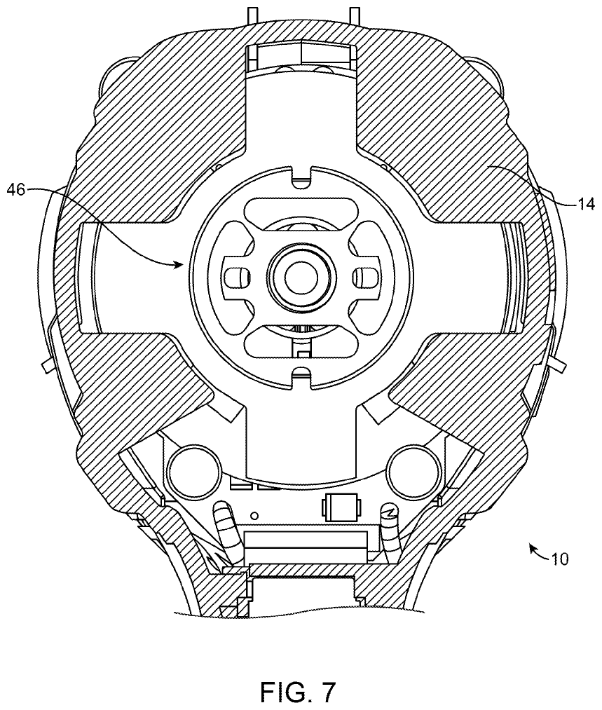

FIG. 7 illustrates the torque transducer 46 in greater detail. The torque transducer 46 may be substantially similar to the transducer assembly of U.S. Pat. No. 10,357,871, the entire contents of which is incorporated herein by reference. The torque transducer 46 detects a torque output of the output shaft 54 of the motor 34 and relays the detected torque to the torque display screen 50 (FIG. 8). In some embodiments, the torque transducer 46 may include an integrated circuited mounted directly on the transducer 46. An integrated circuit enables the transducer 46 to measure torque with greater accuracy. In other embodiments, the power tool 10 may include a strain gauge in place of or in addition to the torque transducer 46.

With reference to FIG. 8, in the illustrated embodiment, a torque display screen 50 coupled with the power tool 10 is described, according to some embodiments. The torque display screen 50 is positioned at or near the rearward end of the power tool 10. Specifically, the torque display screen 50 may be located on an end of the housing 14 that is opposite from the output end 42. The torque display screen 50 is configured to receive a signal from the torque transducer 46 (as described above with reference to FIG. 7) indicating the current level of torque being generated by the motor 34 (which is described below with reference to FIG. 2). The torque value indicated on the torque display screen 50 may optionally be converted to a torque value applied by the power tool 10 to a workpiece (e.g., the torque at the output end 42) by multiplying the measured torque by a gear ratio provided by the transmission 38.

The torque display screen 50 may include a user interface allowing a user to adjust the torque value that is displayed on the torque display screen 50. For example, a user may be able to adjust the units in which torque is displayed. In another example, a user may be able to adjust the torque level that is displayed from a current, real-time reading to a threshold reading that provides confirmation to a user when a specified torque level, such as a desired torque value to be applied to a workpiece, has been reached. In some embodiments, the power tool 10 may include a plurality of LED lights in place of or in addition to the torque display screen 50. The LED lights may be configured to illuminate after the specified torque level has been reached. In some embodiments, this may include illuminating all or some (e.g., only the screen portion behind the torque value, etc.) of the torque display screen 50. The torque display screen 50 and a coupling to a power tool (e.g., power tool 10) therewith may include some or all of the functionality of display screens described in U.S. Pat. No. 10,625,405, granted Apr. 21, 2020, the entire disclosure of which is incorporated by reference herein in its entirety.

Referring to FIG. 2, the motor 34 has a rotor with an output shaft 54. In the illustrated embodiment, the motor 34 is a brushless direct current motor. In other embodiments, the motor 34 may be another type of motor. The output shaft 54 is supported by a rear bearing 58 and a forward bearing 62. The rear bearing 58 is located on a rear side of the motor 34, and the forward bearing 62 is located on a front side of the motor 34. The motor 34 drives the output shaft 54 to transmit torque to the transmission 38.

The transmission 38 is supported within a gear casing 63, which in the illustrated embodiment includes a rear casing portion 64, an intermediate casing portion 65, and a front casing portion 67. The rear casing portion 64 is coupled to and extends into the motor housing portion 22 of the housing 14 and supports the forward bearing 62. The intermediate casing portion 65 is coupled to and extends from the rear casing portion 64, and the front casing portion 67 is coupled to and extends from the intermediate casing portion 65 opposite the rear casing portion 64. A mount 68 is fixed to the interior of the front casing portion 67 and projects from a front end of the front casing portion 67 adjacent to the output end 42. The reaction arm 12 is coupled to the mount 68 and may be selectively coupled to the mount 68 in a plurality of different rotational orientations. For example, in some embodiments, the reaction arm 12 and the mount 68 may include spline patterns that cooperate to rotationally fix the reaction arm 12 in a desired position on the mount 68.

With continued reference to FIG. 2, the transmission 38 includes a plurality of gear sets 66, 70 and an auto-shift mechanism 74. In the illustrated embodiment, the transmission 38 includes a first or rearward gear set 66 and a second or forward gear set 70. Each of the rearward gear set 66 and the forward gear set 70 may include one planetary gear stage or multiple planetary gear stages. In the illustrated embodiment, the rearward gear set 66 and the forward gear set 70 include, in combination, 5 planetary gear stages. Specifically, the rearward gear set 66 includes 2 gear stages and the forward gear set 70 includes 3 gear sets. In other embodiments, the power tool 10 may include fewer or more gear stages. The rearward gear set 66 is positioned between the motor 34 and the auto-shift mechanism 74. The forward gear set 70 is positioned between the auto-shift mechanism 74 and the output end 42 of the power tool 10. As such, at least a portion of the rearward gear set 66 is coupled to the output shaft 54 of the motor 34 such that the output shaft 54 transmits torque to the rearward gear set 66. The rearward gear set 66 transmits torque to the auto-shift mechanism 74. The auto-shift mechanism 74 then transmits torque to the forward gear set 70, which may transmit torque through the output end 42 to apply torque to a workpiece. As described in greater detail below, the auto-shift mechanism 74 is operable to shift a torque transmission path between the rearward gear set 66 and the forward gear set 70 to adjust an output torque level for the power tool 10.

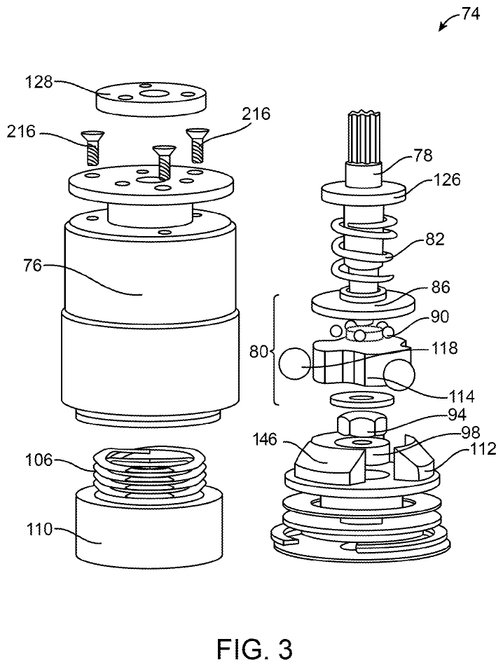

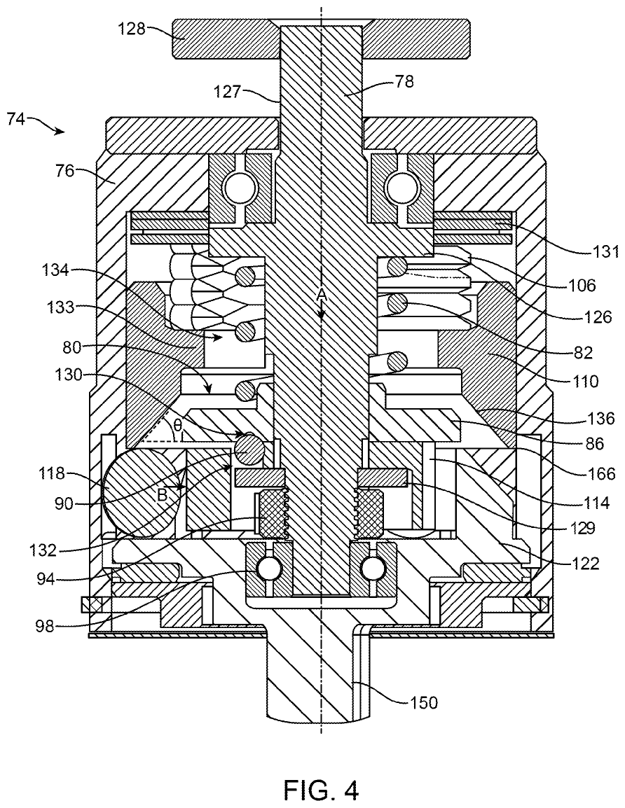

As illustrated in FIGS. 3 and 4, the auto-shift mechanism 74 includes a housing 76, a through shaft 78, and a clutch mechanism 80 including a clutch spring 82, a clutch plate 86, a plurality of clutch balls 90, a clutch nut 94, and a clutch bearing 98. The auto-shift mechanism 74 further includes a shift spring 106, a ramp ring 110, a spinner 114, a plurality of shift balls 118, and an output ring or lock ring 122. The auto-shift mechanism 74 is configured to switch the power tool 10 between a first or initial shift state, in which torque is transmitted between the rearward gear set and the forward gear set along a first torque transmission path, and a second shift state, in which torque is transmitted between the rearward gear set and the forward gear set along a second torque transmission path. In the illustrated embodiment, torque transmitted along the first torque transmission path is less than torque transmitted along the second torque transmission path. In some embodiments, a first range of torques may be transmitted along the first torque transmission path, and a second range of torques may be transmitted along the second torque transmission path. In such embodiments, the greatest torque value in the first range of torques is less than or equal to the lowest torque value in the second range of torques.

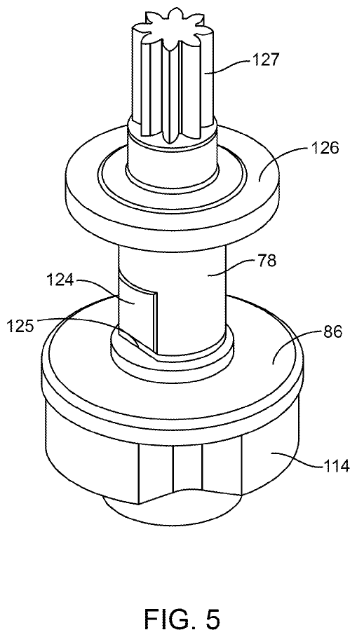

With reference to FIGS. 4 and 5, the through shaft 78 extends from the rearward gear set 66 (FIG. 2) to the lock ring 122. The illustrated through shaft 78 includes two flat surfaces 124, a flange 126, and a splined end portion 127. The splined end portion 127 is coupled with an output (e.g., a last gear stage carrier or second carrier 128) of the rearward gear set 66 (FIG. 2) such that the through shaft 78 is driven by the rearward gear set 66 (e.g., as shown in FIGS. 2 and 4) via the last gear stage carrier 128. The clutch spring 82 is positioned between the flange 126 of the through shaft 78 and the clutch plate 86 to bias the clutch plate 86 toward the spinner 114 (e.g., in the direction of arrow A along a rotational axis of the through shaft 78, as shown in FIG. 4). The clutch plate 86 includes complimentary flat surfaces 125 that engage the flat surfaces 124 of the through shaft 78. As such, the clutch plate 86 is coupled for co-rotation with the through shaft 78 but is axially movable relative to the through shaft 78 against the bias clutch spring 82 (e.g., as shown in FIG. 5). In other words, the flat surfaces 124 of the through shaft 78 and the flat surfaces 125 of the clutch plate 86 inhibit rotation of the clutch plate 86 relative to the through shaft 78 but allow the clutch plate 86 to move axially relative to the through shaft 78.

Referring to FIG. 4, each of the plurality of clutch balls 90 is positioned in a corresponding clutch plate groove 130 defined in the clutch plate 86 and a corresponding spinner groove or aperture 132 defined in the spinner 114 such that the clutch balls 90 are captured between the clutch plate 86 and the spinner 114. The clutch nut 94 is threadedly coupled to the through shaft 78 at a position on the through shaft 78 opposite the rearward gear set 66 (FIG. 2) and retains the clutch mechanism 80 on the through shaft 78 (e.g., against the force of the clutch spring 82). In other words, the clutch nut 94 is threadedly coupled to the through shaft 78 to inhibit the clutch plate 86 and the spinner 114 from sliding off of the through shaft 78.

The spinner 114 includes a spinner washer 129. When the clutch balls 90 are positioned in the spinner apertures 132, the spinner washer 129 inhibits the clutch balls 90 from moving out of the spinner apertures 132 in the direction of arrow A. The spinner 114 is coupled for co-rotation with the through shaft 78 via the clutch mechanism 80, up to a critical or limit torque of the clutch mechanism 80. More specifically, when the power tool 10 is operating at a torque less than or equal to the critical torque, torque is transmitted from the through shaft 78 to the clutch plate 86 and then to the spinner 114 via the clutch balls 90. Thus, the spinner 114, clutch balls 90, and clutch plate 86 all co-rotate together with the through shaft 78 when torque is below the critical torque. If torque exceeds the critical torque, the clutch balls 90 wedge against the grooves 130 in the clutch plate 86 and push the clutch plate 86 in an axial direction opposite the direction of arrow A, thereby compressing the clutch spring 82. The clutch plate 86 may then slip over the clutch balls 90, temporarily decoupling the spinner 114 and the clutch balls 90 from the clutch plate 86 and the through shaft 78. Thus, in the event of a jam, the clutch mechanism 80 permits the motor 34 to continue driving the through shaft 78, which then rotates relative to the spinner 114.

Referring again to FIG. 2, the rearward gear set 66 includes a first planetary stage having a first plurality of planet gears 202 and a first ring gear 204. The first plurality of planet gears 202 is meshed with a pinion 206 coupled to the motor output shaft 54 and also with the first ring gear 204, which surrounds the first plurality of planet gears 202. A first carrier 208 is coupled to each of the first plurality of planet gears 202, such that the first carrier 208 rotates as the planet gears 202 orbit about the inner periphery of the first ring gear 204. The first planetary stage is thus configured to provide a speed reduction and torque increase from the pinion 206 of the output shaft 54 to the first carrier 208. In the illustrated embodiment, the through shaft 78 is coupled for co-rotation with the first carrier 208.

The rearward gear set 66 further includes a second planetary stage having a second plurality of planet gears 210, a second ring gear 212, and the second carrier 128. The splined end portion 127 of the through shaft 78 is meshed with the second plurality of planet gears 210, which also mesh with the second ring gear 212. As such, rotation of the splined end portion 127 drives rotation of the second plurality of planet gears 210. The second carrier 128 is coupled to each of the second plurality of planet gears 210, such that the second carrier 128 rotates as the planet gears 210 orbit about the inner periphery of the second ring gear 212. The second planetary stage is thus configured to provide a speed reduction and torque increase from the through shaft 78 to the second carrier 128.

With continued reference to FIG. 2, the second carrier 128 is fixed to the housing 76 of the auto-shift mechanism 74, such that the housing 76 co-rotates with the second carrier 128. Specifically, the second carrier 128 is fixed to the housing 76 via fasteners 216. In the illustrated embodiment, the second carrier 128 forms a rear end cap of the housing 76. As such, rotation is transmitted from the motor 34 to the housing 76 (e.g., the second torque transmission path) through the first planetary stage of the rearward gear set 66, the through shaft 78, and the second planetary stage of the rearward gear set 66. In other words rotation is transmitted from the motor 34 through two gear stages and the through shaft 78 before reaching the housing 76. As such, the housing 76 rotates at a slower speed and higher torque than the through shaft 78. As described in greater detail below, the auto-shift mechanism 74 is operable to selectively drive the lock ring 122 (which ultimately drives the output end 42 of the power tool 10) from either the spinner 114 (e.g., along the first torque transmission path) or the housing 76 (e.g., along the second torque transmission path), depending on the shift state of the auto-shift mechanism 74. More specifically, when the auto-shift mechanism 74 is in an initial or high-speed shift state, the spinner 114 drives the lock ring 122 at a relatively higher speed and lower torque. When the auto-shift mechanism 74 shifts to a shifted or low-speed shift state, the housing 76 drives the lock ring 122 at a relatively lower speed and higher torque.

Referring to FIG. 4, the shift spring 106 is positioned between a thrust washer 131 and the ramp ring 110. The ramp ring 110 includes an inner flange 133 and a through hole 134. The inner flange 133 is engaged with the shift spring 106, such that the shift spring 106 biases the ramp ring 110 in the direction of arrow A in FIG. 4, and into engagement with the shift balls 118. The ramp ring 110 further includes an inclined surface 136 that faces the clutch mechanism 80 and the spinner 114. The surface 136 is angled at an oblique angle θ relative to an axis perpendicular to the rotational axis of the through shaft 78. As such, when the inclined surface 136 engages the shift balls 118, the inclined surface 136 pushes the shift balls 118 inwardly, in the direction of arrow B in FIG. 4.

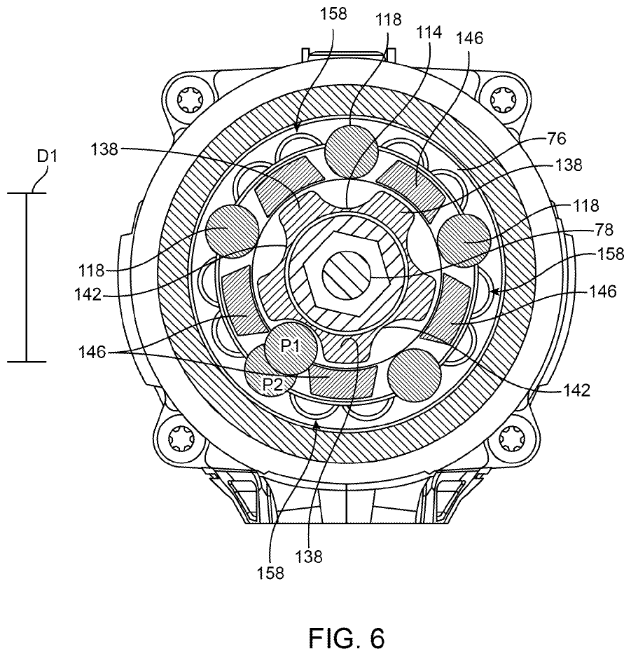

As illustrated in FIG. 6, the spinner 114 includes five spinner lobes 138 in the illustrated embodiment, with a concave and curved cam surface 142 that extends between each of the five spinner lobes 138. Each of the plurality of shift balls 118 is configured to engage a corresponding cam surface 142 under pre-shift conditions (e.g., prior to reaching critical torque), when the shift balls 118 are in a first or an inner position P1. The critical torque may also be referred to as a limit torque, a predetermined torque, a desired torque, and/or a shift torque. The lock ring 122 (FIG. 4) includes a plurality of lock ring lobes 146 generally aligned with the spinner lobes 138. When the spinner 114 rotates with the shift balls 118 in the inner position P1, each of the spinner lobes 138 pushes the shift balls 118 against a corresponding lock ring lobe 146 to cause rotation of the lock ring 122 (FIG. 4). As such, the lock ring 122 co-rotates with the spinner 114 under pre-shift conditions when the shift balls 118 are in the inner position P1. As illustrated in FIG. 4, the lock ring 122 includes an output pinion or lock ring pinion 150 that provides an input (e.g., as a sun gear) to the forward gear set 70 (FIG. 2).

With reference to FIGS. 4 and 6, when the torque transmitted to the lock ring pinion 150 from the spinner 114 reaches the critical torque, the spinner 114 pushes the shift balls 118 radially outwardly with sufficient force to overcome the inward force (e.g., in the direction of arrow B) exerted on the shift balls 118 by the ramp ring 110 and the shift spring 106. The shift balls 118 thus move outwardly to an outer position P2. In the outer position, the shift balls 118 enter into grooves 158 formed about the inner periphery of the housing 76. After the movement of the shift balls 118 to the outer position P2, the housing 76 takes over driving the shift balls 118 and, in turn, the lock ring lobes 146, thereby causing the lock ring 122 to co-rotate with the housing 76 instead of the spinner 114. Thus, upon reaching the critical torque, the auto-shift mechanism 74 shifts from a state in which the spinner 114 drives the lock ring 122 to a state in which the housing 76 of the auto-shift mechanism drives the lock ring 122. Accordingly, when the power tool 10 requires additional torque for a high-torque fastening operation that exceeds the critical torque, the auto-shift mechanism 74 automatically connects the second planetary stage of the rearward gear set 66 into the drivetrain by moving the shift balls 118 from the inner position P1 to the outer position P2 in order to drive the output end 42 of the power tool 10 at a lower speed and higher torque.

In the illustrated embodiment, when the plurality of shift balls 118 are in the first or inner position P1, the plurality of shift balls 118 transmit a first torque to the lock ring pinion 150. When the plurality of shift balls 118 are in the second our outer position P2, the plurality of shift balls 118 transmit a second torque to the lock ring pinion 150. The second torque is greater than the first torque. In some embodiments, the first torque may be a first range of torques, and the second torque may be a second range of torques. In such embodiments, a greatest torque value in the first range of torques is less than or equal to a lowest torque value in the second range of torques.

In use, with reference to FIGS. 2, 4, and 6, prior to turning on the power tool 10, the shift balls 118 are positioned in the inner position P1 in which the shift balls 118 are positioned in engagement with a corresponding cam surface 142 of the spinner 114. A user may actuate a trigger 154 on the power tool 10 to energize the motor 34. In some embodiments, the power tool 10 may include a soft start mode. In the soft start mode, the motor 34 may gradually increase in rotation speed until the reaction arm 12 engages a brace structure near the workpiece. The motor 34 may then increase in rotation speed at a greater rate once the power tool 10 detects that the reaction arm 12 is engaged. In some embodiments, the power tool 10 may determine that the reaction arm 12 is engaged based on feedback from the torque transducer 46. In other embodiments, a strain gauge or another suitable sensor may be coupled to the reaction arm 12 in order to detect engagement of the reaction arm 12 with the brace structure.

As the power tool 10 operates to loosen or tighten the workpiece (i.e. a fastener coupled to the output end 42), torque is transmitted through the auto-shift mechanism 74 to the output end 42 of the power tool 10. Prior to reaching the critical torque value, the power tool 10 operates in the initial shift state. In the initial shift state, the motor 34 effectively drives rotation of and transmits torque to the through shaft 78 via the first planetary stage of the rearward gear set 66. The through shaft 78 then drives rotation of the spinner 114 such that the spinner lobes 138 transmit torque to the lock ring lobes 146 via the shift balls 118. As such, the lock ring 122, and more specifically the lock ring pinion 150, drives rotation of and transmits torque to the forward gear set 70, which in turn drives the output end 42.

If additional torque beyond the critical torque is required to drive the workpiece, the auto-shift mechanism 74 will automatically shift to the low-speed high-torque state (e.g., the second shift state), thereby providing additional torque to the output end 42 of the power tool 10. During auto-shift, the clutch balls 90 move out of the spinner apertures 132 and push the clutch plate 86 against the bias of the clutch spring 82, thereby disengaging from the spinner 114. As the clutch plate 86 disengages from the spinner 114, the spinner 114 pushes the shift balls 118 outwardly from the inner position P1 to the outer position P2 and into the grooves 158 defined in the housing 76 of the auto-shift mechanism 74. The outward movement of the shift balls 118 pushes against the ramp ring 110 and moves the ramp ring 110 against the bias of the shift spring 106 towards the rearward gear set 66. With the shift balls 118 positioned in the grooves 158 of the housing 76, torque begins to be transmitted to the lock ring 122 along the second torque transmission path. That is, the housing 76 transmits torque to the lock ring lobes 146 via the shift balls 118. Shifting to the second torque transmission path engages the second planetary gear stage and increases the amount of torque transmitted to the lock ring 122. The lock ring 122, and more specifically the lock ring pinion 150, then drives rotation of and transmits torque to the forward gear set 70, which in turn drives the output end 42.

Once the applied torque returns below the critical torque, the auto-shift mechanism 74 returns to the initial shift state. Specifically, the shift spring 106 biases the ramp ring 110 towards the forward gear set 70. The ramp ring 110 includes a forward protruding end 166. As the shift spring 106 biases the ramp ring 110 towards the forward gear set 70, the forward protruding end 166 engages the shift balls 118 at a point on each shift ball 118 that is opposite from the through shaft 78 to push each shift ball 118 toward the through shaft 78 and back to the inner positions P1. As such, the ramp ring 110 may return the power tool 10 to the initial shift state.

The critical torque, or shift torque value, at which auto-shifting occurs for the power tool 10 may be altered during manufacturing of the power tool 10. For example, the angle θ of the inclined surface 136 of the ramp ring 110, the spring rate and preload of the shift spring 106 (e.g., the amount of force that is required to compress the shift spring 106), and the outer diameter of the spinner 114 may all be variable factors that determine the shift torque value for the power tool 10. To increase the shift torque value, the angle of the inclined surface 136 of the ramp ring 110, the pre-load and/or the spring rate of the shift spring 106, and the outer diameter of the spinner 114 may all be increased. To decrease the shift torque value, the angle of the inclined surface 136 of the ramp ring 110, the pre-load and/or spring rate of the shift spring 106, and the outer diameter of the spinner 114 may all be decreased.

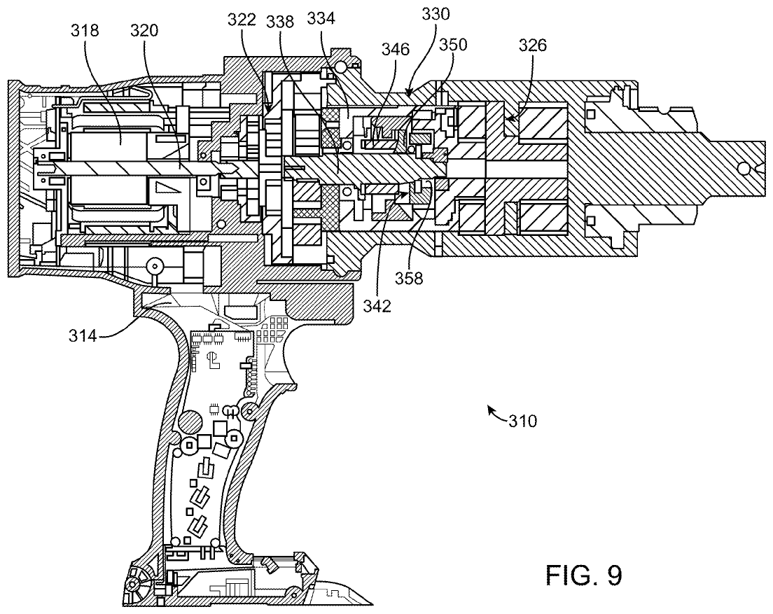

FIG. 9 illustrates another embodiment of a power tool 310. The power tool 310 is substantially similar to the power tool 10 of FIGS. 1 and 2 except for the differences described herein. As illustrated in FIG. 9, the power tool 310 includes a housing 314, a motor 318 supported by the housing 314 and having an output shaft 320, a first or rearward gear set 322, a second or forward gear set 326, and an auto-shift mechanism 330. The first gear set 322 is positioned between the motor 318 and the auto-shift mechanism 330. The second gear set 326 is positioned between the auto-shift mechanism 330 and an output end of the housing 314. As such, the auto-shift mechanism 330 is positioned between the first gear set 322 and the second gear set 326 and is configured to transmit torque from the first gear set 322 to the second gear set 326. In the illustrated embodiment of FIG. 9, auto-shifting occurs between a second and third planetary gear stage rather than between a first and second planetary gear stage (e.g., in the embodiment of the power tool 10 of FIG. 1).

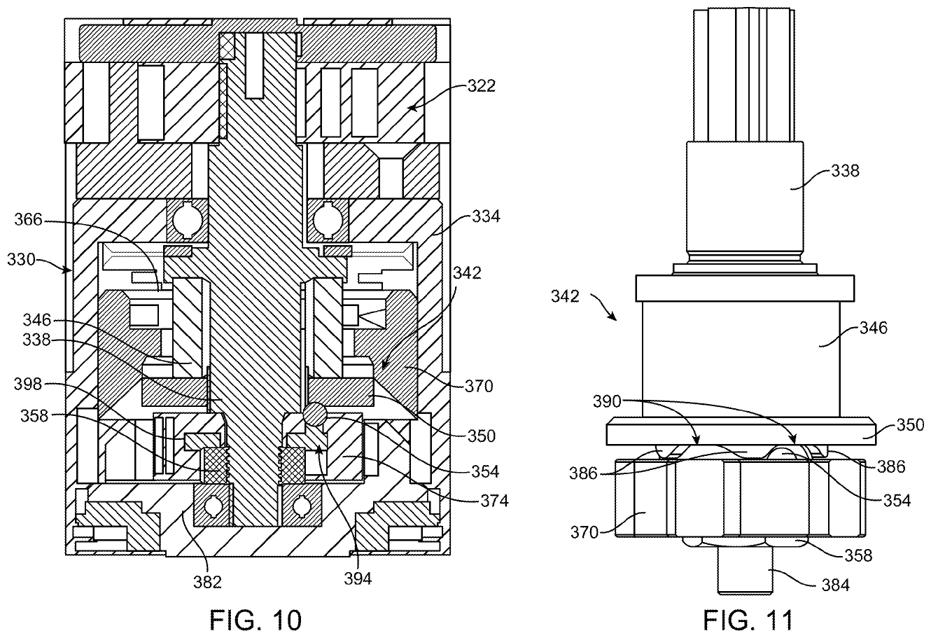

With reference to FIGS. 10 and 11, the auto-shift mechanism 330 includes a shift housing 334, a through shaft 338, and a clutch mechanism 342 having a clutch spring 346, a clutch plate 350, a plurality of clutch balls 354, and a clutch nut 358. The auto-shift mechanism 330 further includes a shift spring 366, a ramp ring 370, a spinner 374, a plurality of shift balls (not illustrated), and a lock ring 382 having a lock ring or output pinion 384. Each of the components of the auto-shift mechanism 330 may be substantially similar to the counterparts in the auto-shift mechanism 74 of the power tool 10 of FIGS. 1 and 2, except for the differences described herein.

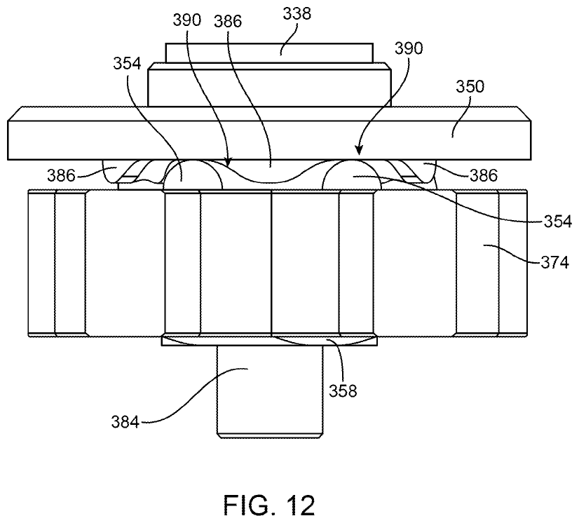

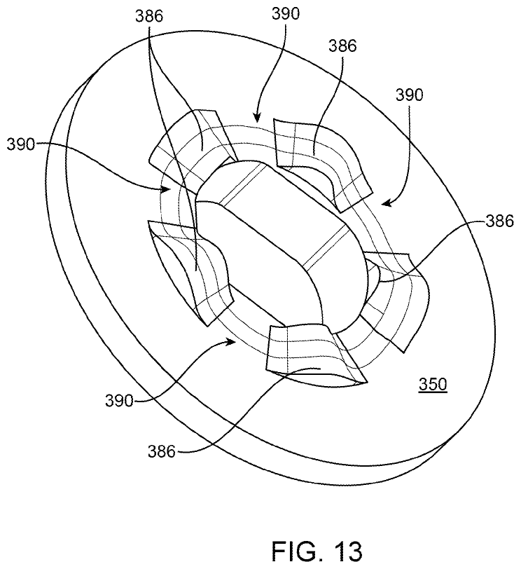

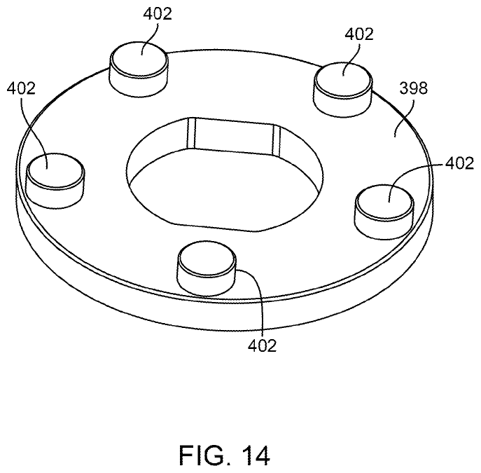

As illustrated in FIGS. 10 and 11, the clutch spring 346 is an elastic body rather than a coiled spring. The clutch spring 346 in FIG. 10 is smaller and stiffer than the clutch spring 82 of FIG. 4, and therefore, may be able to accommodate a higher torque clutch. With reference to FIGS. 11-13, the clutch plate 350 includes a plurality of ramps 386 that define a plurality of troughs 390 between adjacent ramps 386. As such, the clutch balls 354 are configured to move into and out of the troughs 390 of the clutch plate 350 of FIGS. 11-13 for auto-shifting rather than into and out of the grooves 130 in the clutch plate 86 of FIG. 4. With reference to FIGS. 10, 11, and 14, the spinner 374 includes a plurality of spinner apertures 394 (FIG. 10) and a spinner washer 398 positioned between a rearward face of the spinner 374 and the clutch nut 358. Each of the plurality of spinner apertures 394 is configured to at least partially receive a corresponding one of the plurality of clutch balls 354. The spinner washer 398 includes a plurality of protrusions 402 extending toward the clutch plate 350. When each of the plurality of clutch balls 354 is positioned in a corresponding one of the spinner apertures 394, the clutch balls 354 rest on a corresponding protrusion 402 and are at least partially disposed in a corresponding one of the plurality of troughs 390. As such, each of the plurality of ramps 386 rotationally engages a corresponding one of the clutch balls 354 to transfer rotation, or torque, to the spinner 374. When a critical torque value is reached, the clutch plate 350, and more specifically, the plurality of ramps 386 may slip over the clutch balls 354 such that the clutch balls 354 move out of the corresponding trough 390 and the clutch plate 350 moves axially against the bias of the clutch spring 346 such that the clutch plate 350 no longer transfers rotation to the spinner 374 through the clutch balls 354.

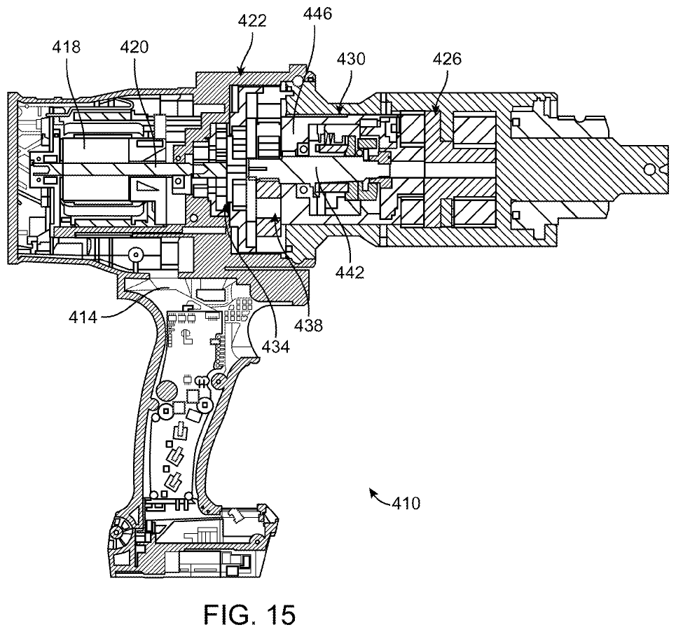

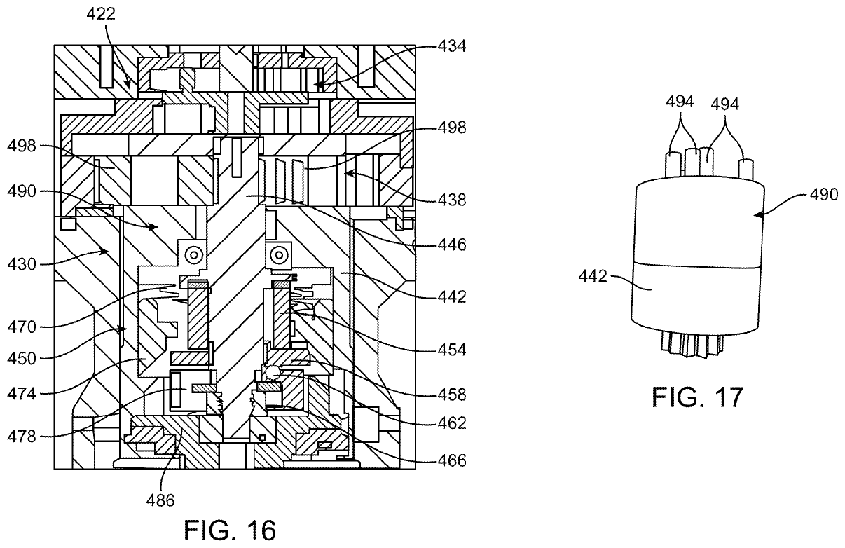

FIG. 15 illustrates another embodiment of a power tool 410. The power tool 410 is substantially similar to the power tool 10 of FIGS. 1 and 2, except for the differences described herein. As illustrated in FIGS. 15 and 16, the power tool 410 includes a housing 414, a motor 418 supported by the housing 414 and having an output shaft 420, a first or rearward gear set 422, a second or forward gear set 426, and an auto-shift mechanism 430. The first gear set 422 is positioned between the motor 418 and the second gear set 426. The first gear set 422 includes at least a first planetary gear stage 434 and a second planetary gear stage 438. The first planetary gear stage 434 is mounted to the output shaft 420. The second planetary gear stage 438 is configured to receive torque from the first planetary gear stage 434. The second gear set 426 is positioned between the auto-shift mechanism 430 and an output end of the housing 414. In the illustrated embodiment of FIG. 15, auto-shifting occurs between a second and third planetary gear stage rather than between a first and second planetary gear stage (e.g., in the embodiment of the power tool 10 of FIG. 1).

As illustrated in FIG. 16, the auto-shift mechanism 430 includes a housing 442, a through shaft 446, and a clutch mechanism 450 having a clutch spring 454, a clutch plate 458, a plurality of clutch balls 462, and a clutch nut 466. In the illustrated embodiment, the clutch mechanism 450 is substantially similar to the clutch mechanism 342 in the power tool 310 of FIGS. 9 and 10. As such, the clutch spring 454 is an elastic body rather than a coiled spring. In other embodiments, the clutch mechanism 450 may be substantially similar to the clutch mechanism 80 in the power tool 10 of FIGS. 2 and 4. The auto-shift mechanism 430 further includes a shift spring 470, a ramp ring 474, a spinner 478, a plurality of shift balls (not illustrated), and a lock ring 486 having a lock ring or output pinion.

With reference to FIGS. 16 and 17, the housing 442 of the auto-shift mechanism 430 is integrally formed with a carrier portion 490 having pins 494 that hold, or secure, a plurality of planet gears 498 of the second planetary gear stage 438 of the first gear set 422. That is, the housing 442 and the carrier portion 490 are not separate components. As such, fastening elements are not required to secure the housing 442 and the carrier portion 490 together. Without the use of a separate carrier, such as the carrier 128 of FIG. 4, the second planetary gear stage 438 is configured to directly drive rotation of the housing 442. Additionally, by integrally forming the housing 442 with the carrier portion 490 such that fastening elements are removed between the housing 442 and the carrier portion 490, the ease of manufacturing of the auto-shift mechanism 430 is improved, and wear and failure of the auto-shift mechanism 430 is reduced.

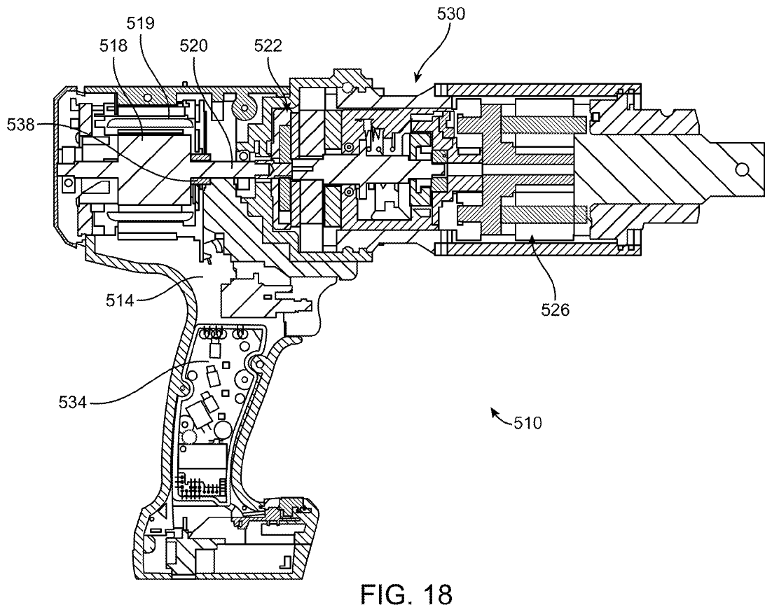

FIG. 18 illustrates another embodiment of a power tool 510. The power tool 510 is substantially similar to the power tool 10 of FIGS. 1 and 2, except for the differences described herein. It should be understood that features and alternatives described with reference to the power tool 10 may be incorporated into the power tool 510 where appropriate, and vice versa.

The illustrated power tool 510 includes a housing 514, a motor 518 having an output shaft 520, a first or rearward gear set 522, a second or forward gear set 526, and an auto-shift mechanism 530. In the illustrated embodiment, the first gear set 522 and the second gear set 526 include, in combination, four planetary gear stages. As such, the overall length of the gear assembly in the power tool 510 is shorter than the power tool 10 of FIG. 2, the power tool 310 of FIG. 9, and the power tool 410 of FIG. 15. In the illustrated embodiment of FIG. 18, auto-shifting occurs between a second and third planetary gear stage rather than between a first and second planetary gear stage (e.g., in the embodiment of the power tool 10 of FIG. 1).

The motor 518 has a plurality of stator coils 519. The stator coils 519 are electrically connected in one of a delta or wye configuration and switchable to the other of the delta or wye configuration via suitable relays or contactors. The switchable delta and wye configurations of the stator coils 519 enables the power tool 510 to switch electronically between different speed-torque combinations. The power tool 510 further includes a printed circuit board assembly (PCBA) 534 with switching electronics (e.g., MOSFETs, IGBTs, or the like) in electrical communication with the stator coils 519, a controller (which may include one or more microprocessors, non-transitory memory, and an input/output interface for communication with electrical/electronic components of the power tool 510). In the illustrated embodiment, a torque transducer 538 is in electrical communication with the PCBA 534.

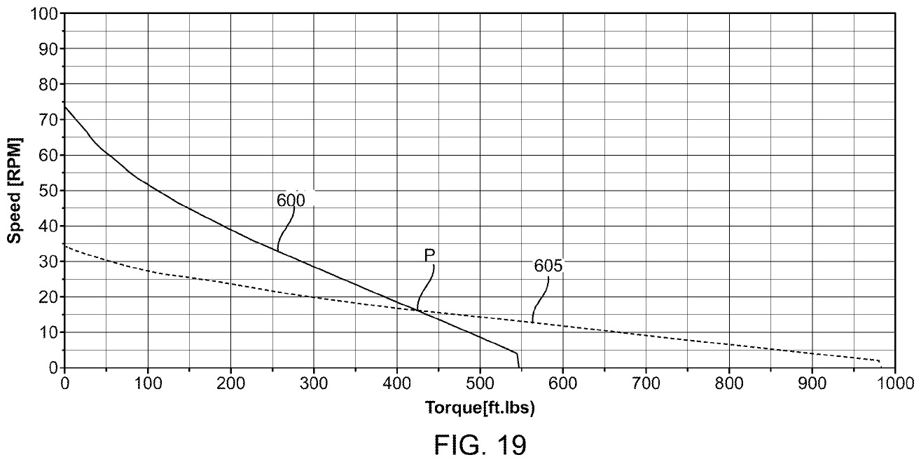

FIG. 20 illustrates an exemplary speed versus torque graph for the motor 518. The motor 518 is operable along a first curve or delta curve 600 when the stator coils 519 are connected in a delta configuration, and along a second curve or wye curve 605 when the stator coils 519 are connected in a wye configuration. The delta curve 600 and the wye curve 605 intersect at a point P. The delta curve 600 is steeper than the wye curve 605 and has a higher no-load speed. For example, when the motor 518 operates on the delta curve 600, the speed at no or low torque may be twice has high as when the motor 518 operates on the wye curve 605. Thus, during low torque tasks such as fastener rundown (i.e., when moving a fastener along threads before the fastener seats and applies an axial load), it may be advantageous to operate the motor 518 with the stator coils 519 connected in the delta configuration. Conversely, during high torque tasks, it may be advantageous to operate the motor 518 with the stator coils 519 connected in the wye configuration. As illustrated in FIG. 19, the wye curve 605 provides a higher maximum torque before stalling the motor 518.

In some embodiments, the controller of the power tool 510 is configured to automatically switch from the delta configuration to the wye configuration upon reaching a threshold torque value corresponding with the point P. The threshold torque value may be determined by the controller based on feedback from the torque transducer 538 (or another suitable sensor or combination of sensors for determining the torque output of the motor 518. Thus, the power tool 510 may advantageously operate with a higher speed during low torque tasks such as fastener rundown, and a higher torque when needed.

In some embodiments, the auto-shift mechanism 530 is also configured to automatically shift at the point P. By shifting at the point P, the auto-shift mechanism 530 may complement the delta-wye electronic shifting described above to provide high speed operation on a low torque (left) side of the point P, and high torque operation on a high torque (right) side of the point P. In yet other embodiments, the shift point of the auto-shift mechanism 530 may differ from the intersection point P of the delta curve 600 and the wye curve 605. In such embodiments, the power tool 510 may effectively be shifted between four different speed/torque settings—a highest speed setting on the delta curve 600 with the auto-shift mechanism 530 in a high speed position, an intermediate high speed setting on the wye cure 605 with the auto-shift mechanism 530 in the high speed position, an intermediate high torque setting on the delta curve 600 with the auto-shift mechanism 530 in a low speed/high torque position, and a highest torque setting on the wye curve 605 with the auto-shift mechanism 530 in the low speed/high torque position.

In some embodiments, in addition to higher rundown speed, the delta-wye configuration of the motor 518 advantageously reduces the number of gear stages required for auto-shifting. With fewer gear stages, the overall length of the power tool 510 may also be reduced. Additionally, having fewer gear stages may improve the mechanical efficiency of the power tool 510. That is, less torque is lost due to friction between the gear stages.

Although the disclosure has been described in detail with reference to certain preferred embodiments, variations and modifications exist within the scope and spirit of one or more independent aspects of the disclosure as described.

Various features and aspects of the disclosure are set forth in the following claims.

What is claimed is:

1. A power tool comprising:
a housing including an output end;
a motor supported by the housing and including an output shaft, the motor configured to drive rotation of the output shaft to generate torque;
a first gear set coupled to the output shaft such that torque is transferred to the first gear set from the output shaft;
a second gear set positioned between the first gear set and the output end; and
an auto-shift mechanism positioned between the first gear stage and the second gear stage, the auto-shift mechanism providing at least a first torque transmission path and a second torque transmission path between the first gear set and the second gear set, the auto-shift mechanism configured to transmit torque between the first gear set and the second gear set along the first torque transmission path when torque generated by the motor is less than a critical torque and configured to transmit torque between the first gear set and the second gear set along the second torque transmission path when torque generated by the motor is greater than the critical torque.

2. The power tool of claim 1, wherein when the auto-shift mechanism transmits torque along the first torque path, the power tool operates at a relatively higher speed and a relatively lower torque than when the auto-shift mechanism transmits torque along the second torque transmission path.

3. The power tool of claim 1, wherein the auto-shift mechanism includes
a shaft coupled to the first gear set,
an output pinion coupled to the second gear set and configured to transmit torque to the second gear set,
a spinner mounted on the shaft,
a shift housing surrounding at least a portion of the shaft and the spinner, and
wherein the spinner is configured to transmit torque to the output pinion when torque is transmitted through the first torque transmission path, and the shift housing is configured to transmit torque to the output pinion when torque is transmitted through the second torque transmission path.

4. The power tool of claim 3, wherein the first gear set includes a first planetary gear stage having a first carrier and a second planetary gear stage having a second carrier,
wherein the shaft is coupled to and is driven by the first carrier,
wherein the second carrier is coupled to and driven by the shaft, and
wherein the shift housing is driven by the second carrier.

5. The power tool of claim 4, wherein the second carrier is integrally formed with the shift housing.

6. The power tool of claim 4, wherein the auto-shift mechanism further includes
a plate mounted to the shaft for rotation with the shaft, and
a plurality of clutch balls at least partially supported and configured to be rotationally driven by the plate, and
wherein the spinner includes a plurality of apertures, each of the plurality of apertures configured to partially receive a corresponding one of the clutch balls such that the plate is configured to drive rotation of the spinner through the clutch balls such that torque is transmitted to the second gear set through the plate and the plurality of clutch balls in the first torque transmission path.

7. The power tool of claim 6, wherein the plurality of clutch balls is configured to move out of the plurality of apertures of the spinner once torque generated by the motor reaches the critical torque to adjust torque transmission between the first gear set and the second gear set from the first torque transmission path to the second torque transmission path.

8. The power tool of claim 1, further comprising a torque display in electrical communication with the torque transducer and configured to provide an indication when the torque generated by the motor reaches the critical torque value.

9. A power tool comprising:
a housing including an output end;
a motor supported by the housing and including an output shaft, the motor configured to drive rotation of the output shaft to generate torque;
a first gear set coupled to the output shaft such that torque is transferred to the first gear set from the output shaft;
a second gear set positioned between the first gear set and the output end; and
an auto-shift mechanism positioned between the first gear set and the second gear set and configured to transmit torque from the first gear set to the second gear set, the auto-shift mechanism including
a shaft coupled to the first gear set,
an output pinion coupled to the second gear set and configured to transmit torque to the second gear set, and
a plurality of shift balls configured to transmit torque to the output pinion;
wherein when the auto-shift mechanism reaches a critical torque, the shift balls are configured to move between a first position in which the plurality of shift balls transmit a first torque to the output pinion and a second position in which the plurality of shift balls transmit a second torque to the output pinion, the second torque greater than the first torque.

10. The power tool of claim 9, wherein the plurality of shift balls is positioned closer to the shaft in the first position than in the second position.

11. The power tool of claim 9, wherein the first torque is a first range of torques, and the second torque is a second range of torques, and
wherein a greatest torque value in the first range of torques is less than or equal to a lowest torque value in the second range of torques.

12. The power tool of claim 9, wherein the auto-shift mechanism further includes
a spinner mounted to shaft, and
a shift housing surrounding at least a portion of the shaft, the plurality of shift balls, and the spinner,
wherein in the first position, the shift balls are positioned rotationally between the spinner and the output pinion, and
wherein in the second position, the shift balls are positioned rotationally between the shift housing and the output pinion.

13. The power tool of claim 12, wherein the output pinion extends from a lock ring having lock ring lobes,
wherein the spinner includes spinner lobes such that rotation of the spinner engages the spinner lobes with the shift balls to push the shift balls into the lock ring lobes and rotate the output pinion, and
wherein the shift housing includes grooves configured to receive the shift balls when the shift balls are in the second position such that the rotation of the shift housing engages the shift housing with the shift balls in the grooves to push the shift balls into the lock ring lobes and rotate the output pinion.

14. The power tool of claim 13, wherein the auto-shift mechanism further includes
a plate mounted to the shaft between the spinner and the first gear set, the plate mounted for rotation with and axial movement relative to the shaft,
a spring biasing the plate toward the spinner, and
a plurality of clutch balls supported between the plate and the spinner such that the plate is configured to drive rotation of the spinner through the clutch balls,
wherein when the auto-shift mechanism reaches the critical torque, the plurality of clutch balls move away from the spinner and push the plate against the bias of the spring such that the plate is inhibited from driving rotation of the spinner.

15. The power tool of claim 14, wherein the plate includes a plurality of ramps that defines a plurality of troughs between adjacent ramps,
wherein each of the plurality of clutch balls is positioned in a corresponding one of the plurality of troughs when the auto-shift mechanism is operating below a critical torque, and
wherein when the auto-shift mechanism reaches the critical torque, each of the plurality of clutch balls engages a corresponding one of the plurality of ramps to push the plate against the bias of the spring.

16. The power tool of claim 9, wherein the motor includes a plurality of stator coils switchable between a delta configuration and a wye configuration.

17. The power tool of claim 16, further comprising a controller configured to switch the plurality of stator coils from the delta configuration to the wye configuration when torque output by the motor reaches the critical torque.

18. A power tool comprising:
a housing including an output end;
a motor supported by the housing and including an output shaft, the motor configured to drive rotation of the output shaft to generate torque;
a first gear set coupled to the output shaft such that torque is transferred to the first gear set from the output shaft;
a second gear set positioned between the first gear set and the output end;
a torque transducer configured to detect and measure the torque generated by the motor;
an auto-shift mechanism positioned between the first gear set and the second gear set and configured to transmit torque from the first gear set to the second gear set, the auto-shift mechanism configured to adjust the amount of torque transmitted from the first gear set to the second gear set after the measured torque reaches a predetermined critical value; and
a display screen configured to display a value of the torque generated by the motor such that the display screen provides an indication when the torque reaches the critical value.

19. The power tool of claim 18, wherein the auto-shift mechanism includes a first torque transmitting mechanism configured to transmit torque from the first gear set to the second gear set before measured torque reaches the critical value and a second torque transmitting mechanism configured to transmit torque from the first gear set to the second gear set after measured torque reaches the critical value.

20. The power tool of claim 18, further comprising a printed circuit board assembly including a controller in electrical communication with the torque transducer such that the controller is configured to receive a signal from the torque transducer indicating the measured torque, wherein the motor includes a plurality of stator coils switchable between a delta configuration and a wye configuration, and wherein the controller is configured to switch between the delta configuration and the wye configuration based on the measured torque.
